(19) United States
(12) Patent Application Publication
(10) Pub. No.: US 2005/0136224 A1
(43) Pub. Date: Jun. 23, 2005

(54) Ultrasonic bonding and embossing of an absorbent product

(75) Inventors: David J. Nickel, Menasha, WI (US); Peiguang Zhou, Appleton, WI (US); Peter Gebhardt, New London, WI (US); Timothy J. Blenke, Neenah, WI (US); Daryl S. Bell, Appleton, WI (US); Thomas D. Ehlert, Neenah, WI (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Kimberly-Clark Worldwide, Inc.

(21) Appl. No.: 10/744,332

(22) Filed: Dec. 22, 2003

(51) Int. Cl. B32B 3/00; B32B 31/00

(52) U.S. Cl. 428/172; 156/73.1; 156/209

(57) ABSTRACT

Ultrasonically bonded laminated absorbent products comprising a liquid permeable top sheet, a liquid impermeable back sheet, an absorbent core positioned between the liquid permeable top sheet and the liquid impermeable back sheet, and an adhesive composition are disclosed. The laminated structure further comprising an embossed pattern stamped onto the liquid permeable top sheet, the liquid impermeable back sheet, the absorbent core, or any combination thereof. The adhesive composition comprises a mixture of atactic and isotactic polymers such that it has melt and flow characteristics similar to those of the topsheet and backsheet.

### BACKGROUND OF THE INVENTION

The present invention is directed to laminated products such as diapers, incontinence garments, and the like. More specifically, the present invention is directed to laminated absorbent products comprising a liquid permeable topsheet, a liquid impermeable backsheet, an absorbent core positioned between the liquid permeable topsheet and the liquid impermeable backsheet, and a bonding or adhesive composition. The topsheet, backsheet and absorbent core are ultrasonically bonded together. The laminated structure further comprises an embossed pattern. The adhesive composition comprises specific mixtures of atactic and isotactic polymers such that the composition is suitable for use with thermoplastic materials to be ultrasonically embossed and bonded.

People rely on disposable absorbent articles to make their lives easier. When the disposable article is worn, the liquid-permeable topsheet is positioned next to the body of the wearer. The topsheet allows passage of bodily fluids into the absorbent core. The liquid-impermeable backsheet helps prevent leakage of fluids held in the absorbent core. The absorbent core generally is designed to have desirable physical properties, such as a high absorbent capacity and high absorption rate, so that bodily fluids can be transported from the skin of the wearer into the disposable absorbent article.

Frequently, one or more components of a disposable absorbent article are first adhesively, and then ultrasonically bonded together to ensure adequate strength of the resulting bond. For example, conventional hot melt adhesives have been used to first bond individual components of the absorbent article, such as the topsheet (also known as, for example, the body-side liner) and backsheet (also known as, for example, the outer cover), together. Conventional hot melt adhesives have also been used to bond discrete pieces, such as fasteners and leg elastics, to the article. In many cases, the bonding together of two components (whether for a permanent-type bond or simply for holding components in place during the manufacturing process) forms a laminated structure in which adhesive is sandwiched between materials (such as components of polymer film and/or components of woven or nonwoven fabrics) that make up the components being bonded together. Once the laminated structure is formed, the laminate will typically undergo an ultrasonic bonding process to impart increased strength in the bonded area of the laminate.

Conventional hot melt adhesives generally utilized in adhesive bonding of thermoplastic materials in laminated absorbent products generally comprise several components including: (1) one or more polymers to provide cohesive strength; (2) a resin or analogous material to provide adhesive strength; (3) waxes, plasticizers, or other materials to modify viscosity; and (4) other additives such as antioxidants and stabilizers. Conventional hot melt adhesives are well known in the industry to those skilled in the art.

Ultrasonic bonding is a conventional bonding technique wherein thermoplastic materials are exposed to a high frequency vibration which results in a heating, melting, and flowing of the thermoplastic materials into each other to form a mechanical and/or chemical bond. Although commonly utilized in the production of laminated absorbent products, ultrasonic bonding can become problematic in the presence of conventional hot melt adhesive materials. For example, during ultrasonic bonding the adhesive composition can result in bleedthrough of the adhesive through one or both of the thermoplastic materials. This bleedthrough can result in at least three significant problems. First, such bleedthrough can result in a discolored end product. Such discoloration, although typically not affecting product performance, is not desirable for consumers who prefer white, uncolored, clean-looking products. Second, the bleedthrough on the end product can result in a tacky product which sticks to skin upon use, which is not desirable for consumers. Third, the bleedthrough can result in an adhesive residue build-up on the ultrasonic bonding equipment as well as other equipment used in the manufacturing process. Such an adhesive build-up can result in the need for frequent cleaning and/or replacement of the machinery, which increases costs. Additionally, the adhesive build-up on the machinery can result in the adhesive composition being deposited on absorbent products in unintended areas, and can weaken any resulting ultrasonic bonds.

Additionally, conventional hot melt adhesive compositions are generally much more amorphous than most typical thermoplastic materials used in absorbent article construction and typically have a lower softening point than such materials. These characteristics may result in the creation of a heat sink during ultrasonic bonding. When a heat sink is created, a high percentage of the ultrasonic energy of the system is used for re-melting the adhesive in the bonded area and less ultrasonic energy remains to melt the thermoplastic materials and perform the ultrasonic bond between the materials. The re-melting of the adhesive is not an optimal use of ultrasonic energy as an adhesively bonded joint is typically not as strong as an ultrasonically bonded joint as the bond strength is limited to the cohesive strength of the adhesive. Also, cohesive strength may vary significantly with temperature and, in the case of absorbent care products, body heat may be sufficient to weaken the strength of the adhesive bond to the point of failure.

Many laminated products are subjected to an embossing process to improve overall product performance and integrity through the introduction of a pattern onto the surface thereof. Embossing may include the patterning of only the liquid permeable top layer, or may include the patterning of the liquid permeable top layer along with the absorbent core. Additionally, in some embodiments, the liquid impermeable back layer can be embossed in combination with the top layer and absorbent core.

Although embossing is a desirable way to improve product performance, many of the fibers and synthetic absorbents used in absorbent articles, and specifically in the absorbent core of the absorbent articles, are difficult to emboss due to the fact that these materials do not have sufficient binding properties to hold and maintain the embossed pattern once applied. Without these binding properties, the absorbent article will lose its form and structural integrity and the embossed pattern will deteriorate. This results in a less than desirable product.

Based on the foregoing, there is a need for a hot melt adhesive composition that can be utilized as an adhesive between thermoplastic and other materials of an absorbent article, yet not significantly interfere with the ultrasonic bonding and embossing processes performed on the absorbent article. It would also be desirable if the adhesive composition could strengthen the ultrasonic bond between the materials and improve the quality of the resulting ultrasonically embossed pattern on the absorbent article.

### SUMMARY OF THE INVENTION

The present invention is directed to disposable products, such as disposable absorbent products, comprising ultrasonically bonded laminated structures. The laminated structures generally comprise a liquid permeable topsheet, a liquid impermeable backsheet, an absorbent core positioned between the liquid permeable topsheet and the liquid impermeable backsheet, and an adhesive composition located on at least one of the liquid permeable topsheet, the liquid impermeable backsheet, or the absorbent core. The laminated structures further comprise an embossed pattern. The embossed pattern can be stamped or otherwise introduced onto at least one of the liquid permeable topsheet, the liquid impermeable backsheet, or the absorbent core. The adhesive composition comprises selected ratios of crystalline and amorphous polymers. When such an adhesive composition is used in the laminated structures, strong ultrasonic bonds can be easily and effectively made between two or more layers without the adverse affects generally associated with the use of conventional adhesive compositions. Additionally, when such an adhesive composition is used on a laminated structure, the binding properties of the structure are substantially improved and the embossed pattern integrity is improved, which further allows for enhanced structural integrity and performance of the absorbent article. Further, these embossed patterns will allow for an aesthetically more desirable product.

Therefore, the present invention is directed to an article comprising an ultrasonically bonded laminated structure. The laminated structure comprises a liquid permeable topsheet, an absorbent core, and an adhesive composition. The adhesive composition comprises an atactic polymer and an isotactic polymer wherein the atactic polymer has a degree of crystallinity of less than about 20% and a number-average molecular weight of from about 1,000 to about 300,000, and the isotactic polymer has a degree of crystallinity of at least about 40% and a number-average molecular weight of from about 3,000 to about 200,000. The liquid permeable topsheet and absorbent core comprise an embossed pattern and are ultrasonically bonded together.

The present invention is further directed to an article comprising an ultrasonically bonded laminated structure. The laminated structure comprises a liquid permeable topsheet, a liquid impermeable backsheet, an absorbent core positioned between the liquid permeable topsheet and the liquid impermeable backsheet, and an adhesive composition. The adhesive composition comprises an atactic polymer and an isotactic polymer wherein the atactic polymer has a degree of crystallinity of less than about 20% and a number-average molecular weight of from about 1,000 to about 300,000 and the isotactic polymer has a degree of crystallinity of at least about 40% and a number-average molecular weight of from about 3,000 to about 200,000. The liquid permeable topsheet, liquid impermeable backsheet, and absorbent core comprise an embossed pattern and are ultrasonically bonded together.

The present invention is further directed to an article comprising an ultrasonically bonded laminated structure. The laminated structure comprises a liquid permeable topsheet, a liquid impermeable backsheet, an absorbent core positioned between the liquid permeable topsheet and the liquid impermeable backsheet, and an adhesive composition. The adhesive composition comprises an atactic polymer and an isotactic polymer wherein the atactic polymer has a degree of crystallinity of less than about 20% and a number-average molecular weight of from about 1,000 to about 300,000 and the isotactic polymer has a degree of crystallinity of at least about 40% and a number-average molecular weight of from about 3,000 to about 200,000. The absorbent core comprises an embossed pattern and the liquid permeable topsheet, liquid impermeable backsheet, and absorbent core are ultrasonically bonded together.

The present invention is further directed to a process for manufacturing an embossed pattern onto an article comprising an ultrasonically bonded laminated structure. The process comprises providing an absorbent core and a liquid permeable topsheet comprising an adhesive composition. The adhesive composition comprises an atactic polymer and an isotactic polymer. The atactic polymer has a degree of crystallinity of less than about 20% and a number-average molecular weight of from about 1,000 to about 300,000 and the isotactic polymer has a degree of crystallinity of at least about 40% and a number-average molecular weight of from about 3,000 to about 200,000. A pattern is ultrasonically embossed onto the liquid permeable topsheet and absorbent core during the ultrasonic bonding of the liquid permeable topsheet and the absorbent core.

The present invention is further directed to a process for manufacturing an embossed pattern onto an article comprising an ultrasonically bonded laminated structure. The process comprises providing a liquid permeable topsheet, a liquid impermeable backsheet, and an absorbent core positioned between the liquid permeable topsheet and liquid impermeable backsheet. The liquid impermeable backsheet comprises an adhesive composition comprising an atactic polymer and an isotactic polymer. The atactic polymer has a degree of crystallinity of less than about 20% and a number-average molecular weight of from about 1,000 to about 300,000 and the isotactic polymer has a degree of crystallinity of at least about 40% and a number-average molecular weight of from about 3,000 to about 200,000. A pattern is ultrasonically bonded onto the liquid impermeable backsheet, liquid permeable topsheet, and absorbent core during the ultrasonic bonding of the liquid permeable topsheet, the liquid impermeable backsheet, and the absorbent core together.

### DETAILED DESCRIPTION OF THE PRESENTLY PREFERRED EMBODIMENTS

The present invention is generally directed to disposable absorbent products comprising a laminated structure. The laminated structure comprises a liquid permeable topsheet, a liquid impermeable backsheet, an absorbent core positioned between the liquid permeable topsheet and the liquid impermeable backsheet, and an adhesive composition. The liquid permeable topsheet, the liquid impermeable backsheet, and the absorbent core are ultrasonically bonded together, and comprise an embossed pattern. The embossed pattern can be stamped or otherwise introduced onto the liquid permeable topsheet, the liquid impermeable backsheet, the absorbent core, or any combination thereof. The adhesive composition comprises selected ratios of crystalline and amorphous polymers to improve the performance of the adhesive in the ultrasonic bonding and embossing processes. For example, the present invention encompasses adhesive compositions comprising selected amounts of polymers having different configurations (e.g., a combination of atactic polypropylene and isotactic polypropylene).

In accordance with one embodiment of the present invention, ultrasonic bonding may be used in conjunction with the adhesive composition described herein to form an ultrasonic bond between various materials of the product in combination with the introduction of an embossed pattern onto the product. Ultrasonic bonding is a conventional process wherein polymeric materials, and specifically thermoplastic materials, are exposed to a high-frequency vibration which results in a heating, melting, and flowing of the materials to form a mechanical and/or chemical bond. As used herein, the term “thermoplastic” is meant to include polymeric materials which can be re-heated and re-melted several times without significant material degradation.

The process is referred to as an “ultrasonic” process because the frequencies of the vibrations utilized are generally above what is considered the upper limit of human hearing (greater than about 18 kilohertz). A typical ultrasonic system utilized for the ultrasonic bonding of thermoplastic materials includes an ultrasonic power supply, the ultrasonic stack, which consists of a converter, a combination of waveguides and a terminating waveguide typically referred to as a sonotrode or horn, an actuator, and an anvil.

The high frequency vibration is typically created through the application of a piezoelectric converter and an appropriate power supply. Piezoelectric materials exhibit a property such that when a voltage is applied to them, they change dimensions. In ultrasonic bonding, a power supply applies an alternating voltage at an ultrasonic frequency to the piezoelectric converter. The converter generates a continuous mechanical vibration referred to as a longitudinal compression wave. This compression wave is transmitted from the converter down the ultrasonic stack through one or more waveguides, which are designed to efficiently transmit a vibration of a given frequency. These waveguides may also function to amplify the vibration wave that is output from the converter to achieve a level more desirable for the bonding process.

At this point, the vibration is coupled into the final component of the stack, the horn. The horn is a type of waveguide designed to be the working tool of the ultrasonic system and is where the vibrational energy is applied to the materials being bonded. Because it is also a waveguide, it is designed to efficiently transmit a vibration of a given frequency and may, in some circumstances, further amplify the vibration wave.

The ultrasonic stack is typically mounted into an actuator mechanism, which has three functions: (1) it mounts the ultrasonic stack in a manner that does not constrain the vibration of the components; (2) it actuates the system to bring the vibrating horn into working contact with the anvil; and (3) it applies a static force. The anvil is designed to be a rigid surface for the ultrasonic horn to work against. The materials to be bonded are placed between the horn and the anvil. The horn is actuated so as to apply a static force on the materials. The anvil may be set to actuate to a fixed stop which creates a small gap (typically smaller than the thickness of the materials) between the horn and the anvil or directly loaded against the horn. In either case, a static force is developed on the materials by the ultrasonic horn and anvil thus creating an embossed bond.

When the ultrasonic system is engaged, the vibration produced at the horn surface creates an alternating compression and relaxation of the materials to be bonded. The alternating high-frequency stress field created in the materials is, to varying degrees, (1) dissipated as heat in the materials (through hysteretic/viscous damping losses); (2) stored in the material as elastic energy which is recoverable by the horn; and/or (3) absorbed and dissipated as heat and vibration in the anvil (typically insignificant). A bond is produced when the heat that is dissipated in the materials reaches the melt temperature of one or more of the materials and they flow together under the static force provided by the actuator to produce a mechanical and/or chemical bond.

In accordance with the present invention, the ultrasonically bonded laminated structure comprises a liquid permeable topsheet, a liquid impermeable backsheet, an absorbent core positioned between the liquid permeable topsheet and the liquid impermeable backsheet along with an adhesive composition.

The topsheet layer of the absorbent article presents a body-facing surface that is compliant, soft-feeling, and non-irritating to the wearer's skin. Further, the topsheet can include hydrophobic or hydrophilic filament sheets, and the like, and is sufficiently porous to be liquid permeable, permitting liquid to readily penetrate through its thickness to reach the absorbent core. It is preferred that the topsheet is hydrophilic so that liquids will transfer through the topsheet faster than if it was not hydrophilic, which will diminish the likelihood that body exudates will flow off the topsheet rather than being absorbed by the absorbent core. To obtain the desired hydrophilic effect, the fibers can be surface treated with an operative amount of surfactant, such as about 0.28% TRITON X-102 surfactant. Other types and amounts of operative surfactants may alternatively be employed. The surfactant can be applied by any conventional means, such as spraying, printing, brush coating or the like.

A suitable topsheet layer may be manufactured from a wide selection of thermoplastic materials, such as porous foams, reticulated foams, thermoplastic materials, apertured plastic films, natural fibers (for example, wood or cotton fibers), synthetic fibers, or a combination of natural and synthetic fibers. Suitable synthetic fibers include polyethylene, polypropylene, polyester, Kraton polymers, polyurethane, nylon or combinations thereof.

The topsheet layer is typically employed to help isolate the wearer's skin from liquids held in the absorbent article. Various woven and nonwoven fabrics can be used for the topsheet layer. For example, the topsheet layer may be composed of a meltblown or spunbonded web of the desired fibers, and may also be a bonded-carded-web. The various fabrics can be composed of natural fibers, synthetic fibers or combinations thereof. For the purposes of the present description, the term “nonwoven web” means a web of fibrous material that is formed without the aid of a textile weaving or knitting process. The term “fabrics” is used to refer to all of the woven, knitted and nonwoven fibrous webs.

In a particular embodiment of the invention, the topsheet layer is a nonwoven, spunbond polypropylene fabric composed of about 2.8-3.2 denier gsm and density of about 0.06 gm/cc.

Additionally, the absorbent article comprises a backsheet layer. The backsheet layer is located along an outside surface of the absorbent article and desirably comprises a thermoplastic material which is configured to be substantially impermeable to liquids. For example, a typical backsheet layer can be manufactured from a thin plastic film, or other flexible, substantially liquid-impermeable material. As used in the present disclosure, the term “flexible” refers to materials which are compliant and which will readily conform to the general shape and contours of the wearer's body. The backsheet layer can prevent the exudates contained in the absorbent core from wetting articles, such as bedsheets and overgarments, which contact the absorbent article. Suitable thermoplastic materials for the backsheet layer can include polyethylene, polypropylene, or combinations thereof. In particular embodiments of the invention, the backsheet layer can include a film, such as a polyethylene film, having a thickness of from about 0.012 millimeters (0.5 mil) to about 0.051 millimeters (2.0 mil). For example, the backsheet film can have a thickness of about 0.032 millimeters (1.25 mil).

Alternative constructions of the backsheet layer may comprise a woven or non-woven fibrous web which has been totally or partially constructed or treated to impart the desired levels of liquid impermeability to selected regions that are adjacent or proximate the absorbent core. For example, the backsheet layer may include a gas-permeable nonwoven fabric material laminated to an appointed facing surface of a polymer film material that may or may not be gas-permeable. Ordinarily, the fabric material is attached to an outward-facing surface of the polymer film material. Other examples of fibrous, cloth-like backsheet layer materials are a stretch-thinned or a stretch-thermal-laminate material composed of a 0.015 mm (0.6 mil) thick polypropylene blown film and a 23.8 g/m² (0.7 ounce per square yard) polypropylene spunbond material (2 denier fibers).

In particular arrangements, a substantially liquid impermeable, vapor permeable backsheet layer may be a composite material which includes a vapor permeable film adhesively laminated to a spunbond material. The vapor permeable film can be obtained from Exxon Chemical Products Incorporated, under the tradename EXXAIRE. The film can include 48-60 weight percent (wt %) linear low density polyethylene and 38-50 wt % calcium carbonate particulates that may be uniformly dispersed and extruded into the film. The stretched film can have a thickness of about 0.018 mm (0.7 mil) and a basis weight of 16-22 grams per square meter (g/m²). The spunbond material can be adhesively laminated to the film, and can have a basis weight of about 27 g/m². The spunbond material can be made using conventional spunbond technology, and can include filaments of polypropylene having a fiber denier of 1.5-3 dpf. The vapor-permeable film may be adhered to the spunbond material using a pressure sensitive, hot melt adhesive at an add-on rate of about 1.6 g/m², and the adhesive can be deposited in the form of a pattern of adhesive swirls or a random fine fiber spray. Another example of a suitable microporous film can be a PMP-1 material, which is available from Mitsui Toatsu Chemicals, Inc., a company having offices in Tokyo, Japan; or an XKO-8044 polyolefin film available from 3M Company of Minneapolis, Minn.

The liquid impermeable, vapor permeable backsheet layer may alternatively include a highly breathable stretch thermal laminate material (HBSTL). The HBSTL material can include a polypropylene spunbond material thermally attached to a stretched breathable film. For example, the HBSTL material may include a 20.4 g/m² (0.6 osy) polypropylene spunbond material thermally attached to an 18.7 g/m² stretched breathable film. The breathable film may include two skin components with each skin component composed of 1-3 wt % EVA/catalloy. The breathable film may also include 55-60 wt % calcium carbonate particulates, linear low density polyethylene, and up to 4.8% low density polyethylene. The stretched breathable film can include a thickness of 0.011-0.013 mm (0.45-0.50 mil) and a basis weight of 18.7 g/m². The spunbond material can be thermally bonded to the breathable film, and can have a basis weight of about 20.4 g/m². The spunbond material can have a fiber denier of 1.5-3 dpf, and the stretched breathable film can be thermally attached to the spunbond material using a “C-star” pattern that provides an overall bond area of 15-20%.

The absorbent article further comprises an absorbent core positioned between the liquid permeable topsheet and the liquid impermeable backsheet. The absorbent core may include a combination of hydrophilic fibers and high-absorbency material. More specifically, the high-absorbency material in the absorbent core can be selected from natural, synthetic, and modified natural polymers and materials. Suitable absorbent materials include cellulosic material, rayon, glass fibers, wood pulp fibers, polyester fibers, polyamide fibers, superabsorbent materials, polypropylene fibers, or combinations thereof. The absorbent core may also be slightly embossed in selected areas.

The absorbent core may have any of a number of shapes. For example, when the absorbent article is a diaper, the absorbent core can be rectangular, I-shaped, or T-shaped and is desirably narrower in the crotch region than in the front or back regions of the diaper. The size and the absorbent capacity of the absorbent core may be selected according to the size of the intended wearer and the liquid loading imparted by the intended use of the diaper. Further, the size and the absorbent capacity of the absorbent core can be varied to accommodate various sized wearers.

The adhesive compositions for use in combination with the materials of the product, such as an absorbent product, which are ultrasonically embossed and bonded together, may be introduced onto the liquid permeable topsheet, the absorbent core, the liquid impermeable backsheet, or any combination thereof before or during manufacturing of the product. The adhesive composition may be applied to any one or more of the materials constructing the product during product formation, it may be applied to an existing formed structure, or it may be applied to discrete components prior to manufacturing. In one specific embodiment, the adhesive composition is introduced onto the absorbent core and/or the outer facing materials during product manufacturing prior to ultrasonic bonding and embossing.

The adhesive compositions described herein for use with thermoplastic materials to be ultrasonically embossed and bonded may be utilized in conventional hot-melt adhesive processing equipment without modification. As such, the adhesive compositions described herein may be used in existing equipment installed for the purpose of processing and applying conventional hot-melt adhesives in the manufacturing process. Furthermore, the adhesive compositions described herein can be applied during the manufacturing process in-line for immediate use, or may be applied to one or more thermoplastic materials off-line, at a distant location, and then shipped to the manufacturing process line for use at a later date.

Additionally, it should be understood that the atactic and isotactic polymers comprising the adhesive compositions described herein could be heated and blended at a site other than the site wherein the laminated absorbent product is being manufactured. For example, atactic and isotactic polymers could be blended using an extruder or hot-melt processing equipment at a first geographic location. The blended polymers could then be allowed to cool and processed to make a solid form such as, for example, pellets. The polymer blend could then be shipped from the first geographic site to a site where the laminated products are made. The polymer blend would simply be heated to substantially liquefy the adhesive composition prior to its being used to make a laminated product comprising an embossed pattern.

The adhesive compositions described herein can be blended in numerous ways in accordance with the present invention. For example, the atactic polymer could be heated in a first container and the isotactic polymer could be heated in a second container before, after, or concurrently with the heating of the atactic polymer and then the two liquefied polymers mixed together in the first container, the second container, or a third container. Alternatively, one of either the atactic or isotactic polymers could be heated in a container until liquefied, at which time the second polymer could be added to the first liquefied polymer and melted. Additionally, both solid polymers could be added to a single container and melted simultaneously to produce a hot melt adhesive. Based on the disclosure herein, one skilled in the art will recognize that the other additional components as discussed herein may also be added to the adhesive compositions. It is noted that the above discussion assumes that the atactic and isotactic polymers are in substantially solid form at room temperature, or at temperatures that are typically present in a working environment suitable for human beings. To the extent that either or both of the polymers are available in substantially liquid form, then those steps providing for heating and melting the polymer can be omitted from the methods of making the adhesive composition.

In accordance with the present invention, the adhesive composition can be formulated with various degrees of crystallinity, which brings its melting temperature into a range similar to many of the thermoplastic materials being ultrasonically bonded together and embossed. The adhesive composition described herein does not act as a substantial heat sink in the bond zone and thus, leaves substantial vibrational energy to perform the ultrasonic bond via melting the materials as described above. Additionally, the adhesive compositions described herein improve the chemical compatibility with many of the thermoplastic materials of interest for ultrasonic bonding. By providing for an improved material compatibility, the adhesive composition improves the strength of the resulting ultrasonic bond; and further, the article can maintain an embossed pattern for a longer period of time. As discussed herein, the embossed pattern allows for further enhanced structural integrity and performance of the absorbent article.

Along with the benefits outlined above, the adhesive compositions described herein do not have the propensity to contaminate the processing equipment and adversely affect the equipment like traditional hot melt adhesives. Also, for thermoplastic materials that are not significantly affected by ultrasonic vibrational energy, the hot melt adhesive described herein makes a highly efficient bonding agent by providing an interface in the bond zone that can be affected by ultrasonic energy.

The adhesive composition useful for use in combination with a liquid permeable topsheet, a liquid impermeable backsheet, and an absorbent core positioned between the liquid permeable topsheet and the liquid impermeable backsheet, which are ultrasonically embossed and bonded together, comprises an atactic polymer and an isotactic polymer. As used herein, the term isotactic polymer refers to a polymer that is at least about 60% isotactic, and suitably at least about 70% isotactic, and more suitably at least about 80% isotactic. As used herein, the term atactic polymer refers to a polymer that is at least about 80% atactic, suitably at least about 90% atactic.

The atactic polymer comprises from about 40% (by weight) to about 90% (by weight) of the adhesive composition and has a degree of crystallinity of about 20% or less, suitably a crystallinity of about 15% or less, and a number average molecular weight of from about 1,000 to about 300,000, suitably from about 3,000 to about 100,000. The isotactic polymer comprises from about 5% (by weight) to about 30% (by weight) of the adhesive composition and has a degree of crystallinity of about 40% or more, suitably about 60% or more, and more suitably about 80% or more, and a number-average molecular weight of from about 3,000 to about 200,000, suitably from about 10,000 to about 100,000.

The adhesive composition is hot melt processable at a temperature of about 450 degrees Fahrenheit or less, suitably 400 degrees Fahrenheit or less, suitably 375 degrees Fahrenheit or less, and still more suitably about 350 degrees Fahrenheit or less. Further, the adhesive composition has a melt index of from about 100 to about 2000 grams per 10 minutes, suitably from about 200 to about 1800 grams per 10 minutes, suitably from about 500 to about 1500 grams per 10 minutes as determined by ASTM D 1238. The melt index is dependent upon the crystallinity, molecular weight, and the molecular weight distribution of the polymers included in the adhesive composition.

The atactic polymer may be the same polymer as the isotactic polymer, or it may be a different polymer than the isotactic polymer. Suitable polymeric materials for preparing the adhesive composition include, for example, polypropylene, polybutene, polyethylene, polystyrene, and combinations thereof. In one embodiment high density polyethylene (HDPE), which is essentially isotactic, and low density polyethylene (LDPE), which is essentially atactic, may be used as the polymers. HDPE generally has a density in the range of from about 0.935 to about 0.980 grams per cubic centimeter, while LDPE generally has a density in the range of from about 0.910 to about 0.935 grams per cubic centimeter.

As used herein, weight percent means the mass of one type of polymer (e.g., atactic) in the adhesive composition divided by the sum of the masses of the other types of polymer (e.g., atactic and isotactic) in the adhesive composition, plus the mass of any additional components that might be present in the adhesive composition, with this value being multiplied by 100. For example, if the adhesive composition comprises 40 grams of atactic polypropylene with 60 grams of isotactic polypropylene, the combination includes 40 weight percent atactic polypropylene.

In addition to the atactic and isotactic polymeric components in the adhesive composition described herein, the composition may additionally comprise up to about 50% or about 60% (by weight) of a combination of additives such as a tackifier, an antioxidant, color pigments, fillers, and/or a polymeric compatibilizer. Examples of suitable tackifiers include PICCOLYTE® S Resins, REGALITE® series, and STAYBELITE® esters, each available from Hercules Incorporated, Wilmington, Del. Also, a suitable tackifier is ESCOREZ, available from Exxon Chemical. The adhesive composition may suitably include from about 10% (by weight) to about 20% (by weight) tackifier. Examples of suitable antioxidants include IRGANOX® 565, available from Ciba-Geigy, POLYGARD®, available from Uniroyal Chemical Co., and ANTIOXIDANT® series, available from Cytec Industries. The adhesive composition may suitably include from about 0.1% (by weight) to about 1.0% (by weight) antioxidant. Examples of suitable color pigments and fillers include titanium dioxide, carbon black, and calcium carbonate. The adhesive composition may suitably include from about 1% (by weight) to about 10% (by weight) color pigments and fillers. Examples of suitable polymer compatibilizers include polypropylene-b-polyethylene, and polypropylene-b-polybutene diblock copolymers. The adhesive composition may suitably include from about 2% (by weight) to about 10% (by weight) polymer compatibilizer, and up to about 15% of a viscosity modifier, such as mineral oil.

The adhesive compositions described herein suitably have an open time of up to about 2 minutes when applied to a thermoplastic material. Alternatively, the adhesive composition can have an open time of up to about 30 seconds, or up to about 10 seconds, or as short as up to about 1 second depending upon the desired application. As used herein, the term “open time” refers to the length of time during which an adhesive composition remains tacky or sticky on the substrate surface prior to solidifying. Open time is affected by the crystallinity of a polymer, such that the greater the level of crystallinity, the shorter the open time. Desirably, the adhesive compositions described herein have open times typically much shorter than conventional hot melt adhesives.

The adhesive compositions described herein can be used in the manufacturing process of laminated disposable absorbent products in multiple areas where an adhesive is required and where ultrasonic bonding and embossing will take place between two thermoplastic materials. Conventional hot melt adhesives, when located in the ultrasonic bonding area along with two thermoplastic materials, simply melt and flow into one or both of the thermoplastic materials being bonded together upon the application of vibrational energy to produce only an adhesive bond which is susceptible to failure upon use. Because conventional hot melt adhesives have different melt and flow characteristics as compared to thermoplastic materials, both thermoplastic materials have limited reactions to ultrasonic energy and, as such, do not have sufficient flow together in the ultrasonic bonding process to form a strong, stable ultrasonic bond. In contrast, the hot melt adhesives described herein have melting characteristics similar to the thermoplastic materials being ultrasonically bonded such that, upon application of the vibrational energy utilized in the ultrasonic bonding process, the thermoplastic materials melt along with the adhesive composition and flow together to form a strong, reliable ultrasonic bond without a significant risk of bleedthrough or failure.

In another embodiment of the present invention, the adhesive composition described herein for use with ultrasonic bonds can be utilized to reinforce or thicken a thermoplastic material in an ultrasonic bonding and embossing zone. Typically, it is very difficult to obtain a high strength ultrasonic bond of thermoplastic materials that have a low basis weight (thin thermoplastic materials that have a small amount of polymer mass) as the materials tend to tear or disintegrate during the ultrasonic bonding process. Similarly, it is typically difficult to obtain a suitable embossed pattern on low basis weight materials. The adhesive compositions described herein can be utilized as material basis weight increasing agents to increase the material basis weight and improve the overall strength and durability of one or more components of a disposable laminated absorbent garment subjected to ultrasonic bonding and embossing without deteriorating the resulting bond; that is, the adhesive compositions may be used to increase the material basis weight of one or more specific thermoplastic components of a laminated product to provide increased material strength of the resulting product as opposed to using a thicker starting material. As such, the adhesive compositions described herein can also serve a dual function of acting as a bonding agent and a material basis weight increasing agent without negatively affecting ultrasonic bonding.

As is evident from the above discussion and known to those skilled in the art, it is typically desirable to utilize thin thermoplastic materials as components when manufacturing disposable laminated absorbent products such that a thin disposable product is produced; that is, it is typically desirable to use thermoplastic materials with small basis weights, generally from about 0.2 osy to about 0.8 osy, and desirably from about 0.2 osy to about 0.6 osy. The reasons for this are severalfold, with the primary reason being cost considerations. When thinner thermoplastic materials are utilized to construct laminated absorbent products, significant cost savings on raw materials can be realized. Additionally, thinner materials generally result in improved flexibility of the resulting product, and improved fit on the wearer. This improved flexibility and fit can result in a more comfortable product with a reduced risk of leaking, and hence a more consumer-friendly product.

Along with cost and flexibility, thinner materials also typically allow for improved breathability of the resulting product. Products with a high degree of breathability are desirable as hot, moist air contained within the product after soiling of the product can be exchanged with the air outside of the product allowing fresh, cool air inside of the product. This results in a more comfortable product for the wearer, and may also improve overall skin health of the wearer by reducing skin over-hydration. Additionally, thinner materials will typically allow leg and waist elastics to perform better such that leakage from the product is minimized. This occurs due to the fact that with thinner materials, the elastic portions of the leg and waist bands do not have to move as much material and perform more efficiently.

Moreover, thinner materials allow for improved packaging as the resulting package containing the product is thinner, and easier to handle and cheaper to transport. This is a direct result of an improvement in the folding and bending characteristics of the absorbent products when thinner materials are used to construct the product. Also, thinner packages have significant consumer appeal as they are easier to transport and do not look as bulky as conventionally packaged absorbent products.

Although it is generally desirable to utilize thin materials during manufacture of laminated disposable absorbent products as discussed above, such thin materials can lead to numerous problems during the ultrasonic bonding of such materials. An ultrasonic bond may cause material failure during manufacturing due to the hammer/anvil combination pushing through or puncturing the material causing it to tear, fracture, and/or shred such that the bond fails and the product is not useable. This is typically a direct result of the material being too thin to allow for the formation of the bond. Similar problems can arise with the other types of bonds and fasteners. Also, as mentioned above, bleedthrough can also be an issue. The short open times of the adhesive compositions described herein reduces the negative effects of adhesive bleedthrough.

In accordance with one embodiment of the present invention, the adhesive compositions described herein can be utilized on a specific thermoplastic material of a disposable laminated absorbent product to increase the material basis weight, and hence the strength, of the treated component such that it is much less likely to fail during manufacture when bonding is performed in the area containing the adhesive composition, or during consumer use. In this embodiment, the adhesive composition is selectively added to a specific region of a thermoplastic material, or the entire thermoplastic material, to increase the material basis weight of that region such that the strength and durability are improved and the material is more resistant to the stress and shear forces imparted thereon during manufacture and ultrasonic bonding. The adhesive composition utilized to increase the material basis weight and the strength of the material may be applied in-line, that is during the manufacturing process, or may be applied off-line in a separate process prior to the introduction of the treated material into the manufacturing process. The adhesive compositions of the present invention act to increase the strength of the treated area by allowing a distribution of force along the entire treated area such that the strength of the area is increased. This embodiment of the present invention allows for an increase in material strength where needed to improve product performance without the need to use a thicker starting material which could significantly increase costs, and also allows for a quality ultrasonic bond to be made between materials.

The adhesive compositions described herein can be applied to the thermoplastic materials by conventional hot melt adhesive equipment as noted above. During application of the adhesive composition to the materials, the adhesive composition can be applied in any pattern or configuration suitable to attain the desired objective. Specifically, the adhesive composition can be applied in a bead configuration, a swirl configuration, or it can be slot coated or melt blown onto the materials.

As noted herein, the adhesive composition for use in combination with the layers of the absorbent article, which are ultrasonically embossed and bonded together, comprises an atactic or amorphous polymer and an isotactic polymer. An atactic polymer is generally less likely to assume a crystalline structure, while an isotactic polymer is generally more likely to assume a crystalline structure. Without being bound to any particular theory, it is believed that an adhesive composition comprising a specified combination of atactic and isotactic polymers, such as atactic and isotactic polypropylene, possesses regions, and/or characteristics, of both a crystalline material and an amorphous material. By changing the relative amounts of atactic and isotactic polymer, or for that matter the relative amounts of polymer having differing degrees of crystallinity, one can change the performance characteristics of the resulting adhesive composition. The adhesive compositions of the present invention generally perform better, and cost less, than conventional hot-melt adhesives. It should be understood, however, that the present invention encompasses adhesive compositions comprising selected polymers having different degrees of crystallinity, such as an adhesive composition comprising atactic and isotactic polypropylene, whether or not the composition possesses all of the advantages discussed herein.

As noted herein, the liquid permeable topsheet, the liquid impermeable backsheet, and the absorbent core, any or all of which may comprise the adhesive composition disclosed herein, may be embossed to provide a specific pattern on one or more of the materials. As will be recognized by one skilled in the art based on the disclosure herein, the embossing can be done on one or more of the materials comprising the product. For example, the embossing may be done on the liquid permeable topsheet alone. In this embodiment, the liquid permeable topsheet would comprise the adhesive composition to aid in the embossing process. In another embodiment, the embossing may be done on the liquid permeable topsheet in combination with the absorbent core. In this embodiment, either or both of the liquid permeable topsheet and absorbent core may comprise the adhesive composition. In this embodiment, it may be desirable to introduce the adhesive composition directly onto the absorbent core to increase the binding properties of the fibers comprising the core. In a still further embodiment, the embossing may be done on the liquid permeable topsheet, the absorbent core, and the liquid impermeable backsheet. In this embodiment, any one, two, or all three of the components may comprise the adhesive composition. In still another embodiment, the embossing may be done on only the absorbent core. In this embodiment, the absorbent core would comprise the adhesive composition.

Embossing is essentially the stamping or rolling of a pattern onto a substrate or structure. In one embodiment, the increased temperature is the result of the application of ultrasonic energy. The combination of heat and pressure, provided by a stamp or pattern roller, reshapes the surface of the material to create the image. Embossed materials will contain a pattern of compressed areas and uncompressed areas. The compressing may be substantially uniformly or non-uniformly applied across the surface of the material. The ultrasonic bonding system discussed herein may be utilized to compress the embossed patterns or designs onto the liquid permeable topsheet layer, the liquid impermeable backsheet layer, the absorbent core, or any combination thereof. When used in combination with the adhesive compositions described herein, ultrasonic embossing can produce high quality embossed patterns, which are frequently judged by the clarity or sharpness of the artistic pattern on the product, its pattern uniformity, and by the feel of the product.

Embossing can make a laminated absorbent product more commercially desirable by providing a more aesthetically pleasing decorative attribute. In addition to the more aesthetically pleasing decorative attribute, embossing allows for functional characteristics such as enhancing the absorbent article's performance and integrity as well. For example, an area of compressed material will provide for more rapid transmission and channeling of fluid, as compared to the uncompressed areas.

In one embodiment of the present invention, at least one of the layers of the product being embossed comprises a thermoplastic polymer comprised of the same material as at least one component of the adhesive composition. For example, if the adhesive composition comprises atactic and isotactic polypropylene, at least one component of the product, such as the liquid permeable top layer, for example, being embossed would comprise polypropylene. In this case, upon application of ultrasonic energy during the embossing process, the thermoplastic polymer melts and flows together with the adhesive composition surrounding the material to form a highly stable embossed pattern. In a specific example, a product may comprise a liquid permeable topsheet comprised of polypropylene and an absorbent core comprised of cellulosic fibers. An adhesive compound comprising atactic and isotactic polypropylene may be introduced onto the liquid permeable topsheet such that upon the application of the ultrasonic energy during embossing, the materials melt together to form a stable embossed pattern.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

1. An article comprising an ultrasonically bonded laminated structure, the laminated structure comprising a liquid permeable topsheet, an absorbent core, and an adhesive composition, the adhesive composition comprising an atactic polymer and an isotactic polymer, the atactic polymer having a degree of crystallinity of less than about 20% and a number-average molecular weight of from about 1,000 to about 300,000 and the isotactic polymer having a degree of crystallinity of at least about 40% and a number-average molecular weight of from about 3,000 to about 200,000, wherein the liquid permeable topsheet and absorbent core comprise an embossed pattern which is ultrasonically bonded together.

2. The article as set forth in claim 1 wherein the degree of crystallinity of the atactic polymer is less than about 15%.

3. The article as set forth in claim 1 wherein the degree of crystallinity of the isotactic polymer is at least about 60%.

4. The article as set forth in claim 1 wherein the number-average molecular weight of the atactic polymer is between about 3,000 and about 100,000.

5. The article as set forth in claim 1 wherein the number-average molecular weight of the isotactic polymer is between about 10,000 and about 100,000.

6. The article as set forth in claim 1 wherein the adhesive composition is hot-melt processable at less than about 400 degrees Fahrenheit.

7. The article as set forth in claim 1 wherein the adhesive composition is hot-melt processable at less than about 375 degrees Fahrenheit.

8. The article as set forth in claim 1 wherein the adhesive composition has a melt-index of from about 100 to about 2000 grams per 10 minutes.

9. The article as set forth in claim 1 wherein the adhesive composition comprises from about 40 to about 90 weight percent of the atactic polymer and from about 5 to about 30 weight percent of the isotactic polymer.

10. The article as set forth in claim 1 wherein the atactic polymer comprises atactic polypropylene.

11. The article as set forth in claim 1 wherein the atactic polymer is selected from the group consisting of low density polyethylene, atactic polystyrene, atactic polybutene, amorphous polyolefin copolymer, and combinations thereof.

12. The article as set forth in claim 11 wherein the low density polyethylene has a density in the range of 0.910 to 0.935 grams per cubic centimeter.

13. The article as set forth in claim 1 wherein the isotactic polymer comprises isotactic polypropylene.

14. The article as set forth in claim 1 wherein the isotactic polymer is selected from the group consisting of high density polyethylene, isotactic polystyrene, isotactic polybutene, and combinations thereof.

15. The article as set forth in claim 14 wherein the high density polyethylene has a density in the range of 0.935 to 0.980 grams per cubic centimeter.

16. The article as set forth in claim 1 wherein the liquid permeable topsheet comprises a material selected from the group consisting of porous foams, reticulated foams, apertured plastic films, thermoplastic materials, natural fibers, synthetic fibers, a mixture of natural and synthetic fibers, and combinations thereof.

17. The article as set forth in claim 16 wherein the synthetic fibers are selected from the group consisting of polyethylene, polypropylene, polyester, Kraton polymers, polyurethane, nylon or combinations thereof.

18. The absorbent article as set forth in claim 1 wherein the absorbent core comprises material selected from the group consisting of cellulosic material, rayon, glass fibers, wood pulp fibers, polyester fibers, superabsorbent materials, polyamide fibers, polypropylene fibers, or combinations thereof.

19. The article as set forth in claim 1 wherein the adhesive composition additionally comprises a further component selected from the group consisting of tackifiers, antioxidants, viscosity modifiers, color pigments, fillers, and polymeric compatibilizers.

20. An article comprising an ultrasonically bonded laminated structure, the laminated structure comprising a liquid permeable topsheet, a liquid impermeable backsheet, an absorbent core positioned between the liquid permeable topsheet and the liquid impermeable backsheet, and an adhesive composition, the adhesive composition comprising an atactic polymer and an isotactic polymer, the atactic polymer having a degree of crystallinity of less than about 20% and a number-average molecular weight of from about 1,000 to about 300,000 and the isotactic polymer having a degree of crystallinity of at least about 40% and a number-average molecular weight of from about 3,000 to about 200,000, wherein the liquid permeable topsheet, liquid impermeable backsheet, and absorbent core comprise an embossed pattern which is ultrasonically bonded together.

21. The article as set forth in claim 20 wherein the degree of crystallinity of the atactic polymer is less than about 15%.

22. The article as set forth in claim 20 wherein the degree of crystallinity of the isotactic polymer is at least about 60%.

23. The article as set forth in claim 20 wherein the number-average molecular weight of the atactic polymer is between about 3,000 and about 100,000.

24. The article as set forth in claim 20 wherein the number-average molecular weight of the isotactic polymer is between about 10,000 and about 100,000.

25. The article as set forth in claim 20 wherein the adhesive composition is hot-melt processable at less than about 400 degrees Fahrenheit.

26. The article as set forth in claim 20 wherein the adhesive composition is hot-melt processable at less than about 375 degrees Fahrenheit.

27. The article as set forth in claim 20 wherein the adhesive composition has a melt-index of from about 100 to about 2000 grams per 10 minutes.

28. The article as set forth in claim 20 wherein the adhesive composition comprises from about 40 to about 90 weight percent of the atactic polymer and from about 5 to about 30 weight percent of the isotactic polymer.

29. The article as set forth in claim 20 wherein the atactic polymer comprises atactic polypropylene.

30. The article as set forth in claim 20 wherein the atactic polymer is selected from the group consisting of low density polyethylene, atactic polystyrene, atactic polybutene, amorphous polyolefin copolymer, and combinations thereof.

31. The article as set forth in claim 30 wherein the low density polyethylene has a density in the range of 0.910 to 0.935 grams per cubic centimeter.

32. The article as set forth in claim 20 wherein the isotactic polymer comprises isotactic polypropylene.

33. The article as set forth in claim 20 wherein the isotactic polymer is selected from the group consisting of high density polyethylene, isotactic polystyrene, isotactic polybutene, and combinations thereof.

34. The article as set forth in claim 33 wherein the high density polyethylene has a density in the range of 0.935 to 0.980 grams per cubic centimeter.

35. The article as set forth in claim 20 wherein the liquid permeable topsheet comprises a material selected from the group consisting of porous foams, thermoplastic materials, reticulated foams, apertured plastic films, natural fibers, synthetic fibers, a mixture of natural and synthetic fibers, and combinations thereof.

36. The article as set forth in claim 35 wherein the synthetic fibers are selected from the group consisting of polyethylene, polypropylene, polyester, Kraton polymers, polyurethane, nylon and combinations thereof.

37. The article as set forth in claim 20 wherein the liquid impermeable backsheet comprises a material selected from the group consisting of polyethylene, polypropylene, and combinations thereof.

38. The article as set forth in claim 20 wherein the absorbent core comprises material selected from the group consisting of cellulosic material, superabsorbent materials, rayon, glass fibers, wood pulp fibers, polyester fibers, polyamide fibers, polypropylene fibers, and combinations thereof.

39. The article as set forth in claim 20 wherein the adhesive composition additionally comprises a further component selected from the group consisting of tackifiers, antioxidants, viscosity modifiers, color pigments, fillers, and polymeric compatibilizers.

40. An article comprising an ultrasonically bonded laminated structure, the laminated structure comprising a liquid permeable topsheet, a liquid impermeable backsheet, an absorbent core positioned between the liquid permeable topsheet and the liquid impermeable backsheet, and an adhesive composition, the adhesive composition comprising an atactic polymer and an isotactic polymer, the atactic polymer having a degree of crystallinity of less than about 20% and a number-average molecular weight of from about 1,000 to about 300,000 and the isotactic polymer having a degree of crystallinity of at least about 40% and a number-average molecular weight of from about 3,000 to about 200,000, wherein the absorbent core comprises an embossed pattern and the liquid permeable topsheet, liquid impermeable backsheet, and absorbent core are ultrasonically bonded together.

41. The article as set forth in claim 40 wherein the degree of crystallinity of the atactic polymer is less than about 15%.

42. The article as set forth in claim 40 wherein the degree of crystallinity of the isotactic polymer is at least about 60%.

43. The article as set forth in claim 40 wherein the number-average molecular weight of the atactic polymer is between about 3,000 and about 100,000.

44. The article as set forth in claim 40 wherein the number-average molecular weight of the isotactic polymer is between about 10,000 and about 100,000.

45. The article as set forth in claim 40 wherein the adhesive composition is hot-melt processable at less than about 400 degrees Fahrenheit.

46. The article as set forth in claim 40 wherein the adhesive composition is hot-melt processable at less than about 375 degrees Fahrenheit.

47. The article as set forth in claim 40 wherein the adhesive composition has a melt-index of from about 100 to about 2000 grams per 10 minutes.

48. The article as set forth in claim 40 wherein the adhesive composition comprises from about 40 to about 90 weight percent of the atactic polymer and from about 5 to about 30 weight percent of the isotactic polymer.

49. The article as set forth in claim 40 wherein the atactic polymer comprises atactic polypropylene.

50. The article as set forth in claim 40 wherein the atactic polymer is selected from the group consisting of low density polyethylene, atactic polystyrene, atactic polybutene, amorphous polyolefin copolymer, and combinations thereof.

51. The article as set forth in claim 50 wherein the low density polyethylene has a density in the range of 0.910 to 0.935 grams per cubic centimeter.

52. The article as set forth in claim 40 wherein the isotactic polymer comprises isotactic polypropylene.

53. The article as set forth in claim 40 wherein the isotactic polymer is selected from the group consisting of high density polyethylene, isotactic polystyrene, isotactic polybutene, and combinations thereof.

54. The article as set forth in claim 53 wherein the high density polyethylene has a density in the range of 0.935 to 0.980 grams per cubic centimeter.

55. The article as set forth in claim 40 wherein the liquid permeable topsheet comprises material selected from the group consisting of porous foams, reticulated foams, apertured plastic films, thermoplastic materials, natural fibers, synthetic fibers, or a combination of natural and synthetic fibers.

56. The article as set forth in claim 55 wherein the synthetic fibers are selected from the group consisting of polyethylene, polypropylene, polyester, Kraton polymers, polyurethane, nylon or combinations thereof.

57. The article as set forth in claim 40 wherein the liquid impermeable backsheet comprises material selected from the group consisting of polyethylene, polypropylene, and combinations thereof.

58. The article as set forth in claim 40 wherein the absorbent core comprises material selected from the group consisting of cellulosic material, rayon, superabsorbent materials, glass fibers, wood pulp fibers, polyester fibers, polyamide fibers, polypropylene fibers, or combinations thereof.

59. The article as set forth in claim 40 wherein the adhesive composition additionally comprises a further component selected from the group consisting of tackifiers, antioxidants, color pigments, viscosity modifiers, fillers, and polymeric compatibilizers.

60. A process for manufacturing an embossed pattern onto an article comprising an ultrasonically bonded laminated structure, the process comprising:
providing a liquid permeable topsheet comprising an adhesive composition, the adhesive composition comprising an atactic polymer and an isotactic polymer, the atactic polymer having a degree of crystallinity of less than about 20% and a number-average molecular weight of from about 1,000 to about 300,000 and the isotactic polymer having a degree of crystallinity of at least about 40% and a number-average molecular weight of from about 3,000 to about 200,000 ;
providing an absorbent core;
ultrasonically embossing a pattern onto the liquid permeable topsheet and absorbent core; and
ultrasonically bonding the liquid permeable topsheet and the absorbent core together.

61. The process as set forth in claim 60 wherein the degree of crystallinity of the atactic polymer is less than about 15%.

62. The process as set forth in claim 60 wherein the degree of crystallinity of the isotactic polymer is at least about 60%.

63. The process as set forth in claim 60 wherein the number-average molecular weight of the atactic polymer is between about 3,000 and about 100,000.

64. The process as set forth in claim 60 wherein the number-average molecular weight of the isotactic polymer is between about 10,000 and about 100,000.

65. The process as set forth in claim 60 wherein the adhesive composition is hot-melt processable at less than about 400 degrees Fahrenheit.

66. The process as set forth in claim 60 wherein the adhesive composition is hot-melt processable at less than about 375 degrees Fahrenheit.

67. The process as set forth in claim 60 wherein the adhesive composition has a melt-index of from about 100 to about 2000 grams per 10 minutes.

68. The process as set forth in claim 60 wherein the adhesive composition comprises from about 40 to about 90 weight percent of the atactic polymer and from about 5 to about 30 weight percent of the isotactic polymer.

69. The process as set forth in claim 60 wherein the atactic polymer comprises atactic polypropylene.

70. The process as set forth in claim 60 wherein the atactic polymer is selected from the group consisting of low density polyethylene, atactic polystyrene, atactic polybutene, amorphous polyolefin copolymer, and combinations thereof.

71. The process as set forth in claim 70 wherein the low density polyethylene has a density in the range of 0.910 to 0.935 grams per cubic centimeter.

72. The process as set forth in claim 60 wherein the isotactic polymer comprises isotactic polypropylene.

73. The process as set forth in claim 60 wherein the isotactic polymer is selected from the group consisting of high density polyethylene, isotactic polystyrene, isotactic polybutene, and combinations thereof.

74. The process as set forth in claim 73 wherein the high density polyethylene has a density in the range of 0.935 to 0.980 grams per cubic centimeter.

75. The process as set forth in claim 60 wherein the liquid permeable topsheet comprises material selected from the group consisting of porous films, reticulated foams, apertured plastic films, natural fibers, thermoplastic materials, synthetic fibers, or a combination of natural and synthetic fibers.

76. The process as set forth in claim 75 wherein the synthetic fibers are selected from the group consisting of polyethylene, polypropylene, polyester, Kraton polymers, polyurethane, nylon or combinations thereof.

77. The process as set forth in claim 60 wherein the absorbent core comprises material selected from the group consisting of cellulosic materials, superabsorbent materials, rayon, glass fibers, wood pulp fibers, polyester fibers, polyamide fibers, polypropylene fibers, or combinations thereof.

78. The process as set forth in claim 60 wherein the adhesive composition additionally comprises a further component selected from the group consisting of tackifiers, antioxidants, viscosity modifiers, color pigments, fillers, and polymeric compatibilizers.

79. A process for manufacturing an embossed pattern onto an article comprising an ultrasonically bonded laminated structure, the process comprising:
providing a liquid permeable topsheet;
providing a liquid impermeable backsheet comprising an adhesive composition, the adhesive composition comprising an atactic polymer and an isotactic polymer, the atactic polymer having a degree of crystallinity of less than about 20% and a number-average molecular weight of from about 1,000 to about 300,000 and the isotactic polymer having a degree of crystallinity of at least about 40% and a number-average molecular weight of from about 3,000 to about 200,000;
providing an absorbent core positioned between the liquid permeable topsheet and the liquid impermeable backsheet;
ultrasonically embossing a pattern onto the liquid impermeable backsheet, the liquid permeable topsheet, and the absorbent core; and
ultrasonically bonding the liquid permeable topsheet, the liquid impermeable backsheet, and the absorbent core together.

80. The process as set forth in claim 79 wherein the degree of crystallinity of the atactic polymer is less than about 15%.

81. The process as set forth in claim 79 wherein the degree of crystallinity of the isotactic polymer is at least about 60%.

82. The process as set forth in claim 79 wherein the number-average molecular weight of the atactic polymer is between about 3,000 and about 100,000.

83. The process as set forth in claim 79 wherein the number-average molecular weight of the isotactic polymer is between about 10,000 and about 100,000.

84. The process as set forth in claim 79 wherein the adhesive composition is hot-melt processable at less than about 400 degrees Fahrenheit.

85. The process as set forth in claim 79 wherein the adhesive composition is hot-melt processable at less than about 375 degrees Fahrenheit.

86. The process as set forth in claim 79 wherein the adhesive composition has a melt-index of from about 100 to about 2000 grams per 10 minutes.

87. The process as set forth in claim 79 wherein the adhesive composition comprises from about 40 to about 90 weight percent of the atactic polymer and from about 5 to about 30 weight percent of the isotactic polymer.

88. The process as set forth in claim 79 wherein the atactic polymer comprises atactic polypropylene.

89. The process as set forth in claim 79 wherein the atactic polymer is selected from the group consisting of low density polyethylene, atactic polystyrene, atactic polybutene, amorphous polyolefin copolymer, and combinations thereof.

90. The process as set forth in claim 89 wherein the low density polyethylene has a density in the range of 0.910 to 0.935 grams per cubic centimeter.

91. The process as set forth in claim 79 wherein the isotactic polymer comprises isotactic polypropylene.

92. The process as set forth in claim 79 wherein the isotactic polymer is selected from the group consisting of high density polyethylene, isotactic polystyrene, isotactic polybutene, and combinations thereof.

93. The process as set forth in claim 92 wherein the high density polyethylene has a density in the range of 0.935 to 0.980 grams per cubic centimeter.

94. The process as set forth in claim 79 wherein the liquid permeable topsheet comprises material selected from the group consisting of porous films, thermoplastic materials, reticulated foams, apertured plastic films, natural fibers, synthetic fibers, or a combination of natural and synthetic fibers.

95. The process as set forth in claim 94 wherein the synthetic fibers are selected from the group consisting of polyethylene, polypropylene, polyester, Kraton polymers, polyurethane, nylon or combinations thereof.

96. The process as set forth in claim 79 wherein the liquid impermeable backsheet comprises material selected from the group consisting of polyethylene, polypropylene, or combinations thereof.

97. The process as set forth in claim 79 wherein the absorbent core comprises material selected from the group consisting of cellulosic material, superabsorbent materials, rayon, glass fibers, wood pulp fibers, polyester fibers, polyamide fibers, polypropylene fibers, or combinations thereof.

98. The process as set forth in claim 79 wherein the adhesive composition additionally comprises a further component selected from the group consisting of tackifiers, antioxidants, viscosity modifiers, color pigments, fillers, and polymeric compatibilizers.

99. An article comprising an ultrasonically bonded laminated structure, the laminated structure comprising an absorbent core and an adhesive composition, the adhesive composition comprising an atactic polymer and an isotactic polymer, the atactic polymer having a degree of crystallinity of less than about 20% and a number-average molecular weight of from about 1,000 to about 300,000 and the isotactic polymer having a degree of crystallinity of at least about 40% and a number-average molecular weight of from about 3,000 to about 200,000, wherein the absorbent core comprises an ultrasonically embossed pattern.

100. The article as set forth in claim 99 wherein the degree of crystallinity of the atactic polymer is less than about 15%.

101. The article as set forth in claim 99 wherein the degree of crystallinity of the isotactic polymer is at least about 60%.

102. The article as set forth in claim 99 wherein the number-average molecular weight of the atactic polymer is between about 3,000 and about 100,000.

103. The article as set forth in claim 102 wherein the number-average molecular weight of the isotactic polymer is between about 10,000 and about 100,000.

104. The article as set forth in claim 99 wherein the adhesive composition is hot-melt processable at less than about 400 degrees Fahrenheit.

105. The article as set forth in claim 99 wherein the adhesive composition is hot-melt processable at less than about 375 degrees Fahrenheit.

106. The article as set forth in claim 99 wherein the adhesive composition has a melt-index of from about 100 to about 2000 grams per 10 minutes.

107. The article as set forth in claim 99 wherein the adhesive composition comprises from about 40 to about 90 weight percent of the atactic polymer and from about 5 to about 30 weight percent of the isotactic polymer.

108. The article as set forth in claim 99 wherein the atactic polymer comprises atactic polypropylene.

109. The article as set forth in claim 99 wherein the atactic polymer is selected from the group consisting of low density polyethylene, atactic polystyrene, atactic polybutene, amorphous polyolefin copolymer, and combinations thereof.

110. The article as set forth in claim 109 wherein the low density polyethylene has a density in the range of 0.910 to 0.935 grams per cubic centimeter.

111. The article as set forth in claim 99 wherein the isotactic polymer comprises isotactic polypropylene.

112. The article as set forth in claim 99 wherein the isotactic polymer is selected from the group consisting of high density polyethylene, isotactic polystyrene, isotactic polybutene, and combinations thereof.

113. The article as set forth in claim 112 wherein the high density polyethylene has a density in the range of 0.935 to 0.980 grams per cubic centimeter.
